(19) United States
(12) Patent Application Publication
(10) Pub. No.: US 2004/0072488 A1
(43) Pub. Date: Apr. 15, 2004

(54) Cleaning sheets having long-lasting perfume odor

(75) Inventors: Stephen Lee Childs, Cincinnati, OH (US); Douglas Michael McGahan, Milford, OH (US); George Kavin Morgan, Hamilton, OH (US); Nirav Satish Shah, Castro Valley, CA (US); Mark Gary Cipollone, New Richmond, OH (US); Jodi Lynn Russell, Hayward, CA (US); Arthur Wong, West Chester, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH

(21) Appl. No.: 10/680,594

(22) Filed: Oct. 7, 2003

Related U.S. Application Data
(63) Continuation of application No. PCT/US02/11394, filed on Apr. 11, 2002.
(60) Provisional application No. 60/283,487, filed on Apr. 12, 2001.

(51) Int. Cl. B32B 27/04

(52) U.S. Cl. 442/96

(57) ABSTRACT

Cleaning sheets having long-lasting perfume odor comprise a substrate, perfume, and additive material having a melting point of at least about −15° C., wherein the perfume and additive material are affixed to the substrate. In a preferred embodiment, the perfume and additive material are first blended together and then affixed to the substrate, such that the blend of perfume and additive material has a melting point of at least about 20° C. Methods of imparting perfume odor to a surface, and optionally removing dust or the like from the surface, comprise the step contacting, preferably wiping, the surface with a cleaning sheet of the present invention.

### CROSS REFERENCE TO RELATED APPLICATIONS

This application is a continuation application of prior copending International Application No. PCT/US02/11394 filed Apr. 11, 2002, designating the U.S., which claims the benefit of U.S. Provisional Application Serial No. 60/283,487, filed Apr. 12, 2001.

### TECHNICAL FIELD

The present invention relates to cleaning sheets that have a long-lasting perfume odor and that are particularly suitable for removal and entrapment of dust, lint, hair, sand, food crumbs, grass and the like from surfaces.

BACKGROUND OF THE INVENTION

The use of nonwoven sheets for dry dust-type cleaning are known in the art. Such sheets typically utilize a composite of fibers where the fibers are bonded via adhesive, entangling or other forces. See, for example, U.S. Pat. No. 3,629,047 and U.S. Pat. No. 5,144,729. To provide a durable wiping sheet, reinforcement means have been combined with the staple fibers in the form of a continuous filament or network structure. See, for example, U.S. Pat. No. 4,808,467, U.S. Pat. No. 3,494,821 and U.S. Pat. No. 4,144,370. Also, to provide a product capable of withstanding the rigors of the wiping process, prior nonwoven sheets have employed strongly bonded fibers via one or more of the forces mentioned above. While durable materials are obtained, such strong bonding may adversely impact the materials' ability to pick up and retain particulate dirt. In an effort to address this concern, U.S. Pat. No. 5,525,397 to Shizuno et al. describes a cleaning sheet comprising a polymeric network layer and at least one nonwoven layer, wherein the two layers are lightly hydroentangled so as to provide a sheet having a low entanglement coefficient. The resulting sheet is said to provide strength and durability, as well as improved dust collecting performance because the composite fibers are lightly hydroentangled. Sheets having a low entanglement coefficient (i.e., not more than 500 m) are said to offer better cleaning performance because a greater degree of fibers are available for contact with dirt.

U.S. Pat. No. 6,143,393 issued Nov. 7, 2000 to Abe et al. describes a cleaning product for collecting dust which comprises a base sheet and at least one layer of filaments or split yarns oriented in one direction, the base sheet and the layer are stacked and bonded together at a plurality of bonding lines extending in a direction intersecting with the one direction, and the base sheet is cut together with the layer intermittently in the intersecting direction between adjacent bonding lines to form cutting portions, thereby forming brushing portions with the layer. The cleaning product preferably includes an oily agent, such as mineral oil, for easy adsorption of the dusts. In addition to the oily agent, the cleaning product can also incorporate with the oily agent materials such as deodorant, moistening agent, disinfectant, and cleaning chemical such as surfactant.

There remains, however, a desire to create a cleaning sheet that has a long-lasting perfume odor and that can impart a perfume odor to the surface being cleaned. Cleaning sheets having perfume odor tend to enhance the cleaning experience for consumers and make cleaning chores more pleasurable. As a result, consumers desire cleaning sheets that have perfume odor and that are able to impart a perfume odor to the surfaces being cleaned, such that the perfume odor permeates the consumers' environment.

### SUMMARY OF THE INVENTION

The present invention relates to cleaning sheets comprising a substrate, perfume, and additive material having a melting point of at least about −15° C., wherein the perfume and the additive material are affixed to the substrate. The present cleaning sheets exhibit a long-lasting perfume odor and are used to effectively pick-up and retain particulate material from surfaces, especially household surfaces. The present cleaning sheets can also impart a perfume odor to the surfaces being cleaned with the sheets.

Perfumes tend to be comprised of relatively volatile materials, such that when perfume is affixed to a substrate, the perfume odor tends to be quickly lost over time. By affixing to the substrate a perfume along with an additive material having a melting point of at least about −15° C., the additive material helps to prevent the more volatile perfume raw materials from rapidly volatilizing from the substrate. It is preferred that the perfume and additive material are first blended together and then affixed to the substrate, such that the blend of perfume and additive material has a melting point of at least about 20° C. The resulting cleaning sheets of the present invention have a long-lasting perfume odor, even after being stored for relatively long periods of time.

The present invention also encompasses a method of removing dust or the like from a surface comprising the step of contacting the surface with a cleaning sheet of the present invention. In addition, the present cleaning sheets can provide a perfume odor to a surface being wiped with the cleaning sheets, without leaving an unacceptable residue on the surface. As such, the present invention further relates to a method of imparting perfume odor to a surface comprising contacting the surface with a cleaning sheet of the present invention. The perfume odor imparted to the treated surface is relatively long-lasting, due to the unique mixture of perfume and additive material affixed to the substrate.

The present invention further relates to cleaning implements comprising the present cleaning sheets; processes for manufacturing cleaning sheets; and articles of manufacture comprising a cleaning sheet of the present invention packaged in a container.

### BRIEF DESCRIPTION OF THE DRAWINGS

FIG. 1 is a graph of “Perfume Fraction Remaining” versus “Time (hours)” for Test Samples #14 as described in Example II hereinafter.

### DETAILED DESCRIPTION OF THE INVENTION

I. Cleaning Sheets

The cleaning sheets of the present invention comprise a substrate, perfume, and an additive material, wherein the perfume and additive material are affixed to said substrate. The additive material has a melting point of at least about −15° C., preferably at least about 20° C., and more preferably at least about 35° C. The perfume and additive material are preferably first blended together and then affixed to the substrate such that the blend of perfume and additive material has a melting point of at least about 20° C., preferably at least about 25° C., and more preferably at least about 30° C.

As used herein, the phrase “melting point” refers to the temperature at which a solid changes to a liquid. Where available, we have chosen to use the standard melting temperature(s) as quoted in published literature. For those components and/or blends where no “melting point” is available, the phrase “melting point” refers, for a pure compound, an impure mixture or a solution, to the temperature at which the maximum endothermic heat flow is observed for a melting state change by differential scanning calorimetry (“DSC”) using a Perkin-Elmer model DSC 7 differential scanning calorimeter to scan at a range of from −20° C. to 80° C. at a rate of 5° C./min. Where discrepency exists between published “melting points”, the experimentally defined “melting point” applies.

A. Substrates

The present invention encompasses cleaning sheets comprising a substrate, an additive material, and a perfume that is selected to provide a long-lasting perfume odor, both for the cleaning sheet itself and also on the surfaces cleaned with the cleaning sheet, while maintaining the ability of the cleaning sheet to pick up and retain particulate material from surfaces, while minimizing the amount of residue left on the surface being cleaned. If the type of additive material and perfume on the substrate of the cleaning sheet are not carefully selected, the sheet will not exhibit long-lasting perfume odor and will tend to leave a residue on the surface being cleaned, resulting in filming and streaking of the surface that is unacceptable to consumers.

The substrates of the cleaning sheets of the present invention typically have a total aggregate basis weight of at least about 20 g/m², preferably at least about 40 g/m², and more preferably at least about 60 g/m². The total aggregate basis weight of the substrates of the present cleaning sheets is typically no greater than about 275 g/m², preferably no greater than about 200 g/m², and more preferably no greater than about 150 g/m².

The substrates of the present cleaning sheets can be made using either a woven or nonwoven process, or by forming operations using melted materials laid down on forms, especially in belts, and/or by forming operations involving mechanical actions/modifications carried out on films. The structures are made by any number of methods (e.g., spunbonded, meltblown, hydroentangled, resin bonded, heat-bonded, air-through bonded, etc.), once the desired characteristics are known. However, the preferred structures are nonwoven, and especially those formed by hydroentanglement and/or heat-bonding as is well known in the art, since they can provide highly desirable open structures. Therefore, preferred cleaning sheets are nonwoven structures having the characteristics described herein. Materials particularly suitable for forming the preferred nonwoven cleaning sheet of the present invention include, for example, natural fibers, e.g. wood pulp, cotton, wool, and the like, as well as biodegradeable fibers, such as polylactic acid fibers, and synthetic fibers such as polyolefins (e.g., polyethylene and polypropylene), polyesters, polyamides, synthetic cellulosics (e.g., RAYON®, Lyocell), cellulose acetate, bicomponent fibers, and blends thereof. Also useful are natural fibers, such as cotton or blends thereof and those derived from various cellulosic sources, however these are not preferred. Preferred starting materials for making the cleaning sheets of the present invention are synthetic materials, which may be in the form of carded, spunbonded, meltblown, airlaid, or other structures. Cleaning sheets comprising synthetic materials or fibers typically have desirable electrostatic properties, which is preferred. Particularly preferred are polyesters, especially carded polyester fibers. The degree of hydrophobicity or hydrophilicity of the fibers is optimized depending upon the desired goal of the sheet, either in terms of type of soil to be removed, the type of perfume and additive material that is provided, biodegradability, availability, and combinations of such considerations. In general, the more biodegradable materials tend to be hydrophilic, but the more effective materials tend to be hydrophobic.

Although substrates comprising synthetic fibers (including mixtures, up to 100%, of synthetic and natural fibers) are preferred, affixing perfume to such substrates can be more difficult than affixing perfume to substrates consisting of only natural fibers, as natural fibers tend to adsorb perfume more effectively than synthetic fibers. As a result, if the substrate of the present cleaning sheet is comprised of at least some synthetic fibers, it is especially important and can be beneficial to have the additive material to help affix the perfume to the substrate.

The substrates of the present cleaning sheets may be formed from a single fibrous layer, but preferably are a composite of at least two separate layers. As noted above, preferred substrates in the cleaning sheets in the present invention include a variety of structures, such as hydroentangled substrates and/or heat-bonded substrates.

The present cleaning sheets comprise a substrate having affixed thereto a perfume and an additive material. The type and level of perfume and additive material is selected such that the cleaning sheet exhibits a long-lasting perfume odor and has the ability to effectively pick-up and retain particulate material, while maintaining the electrostatic properties of the cleaning sheet and minimizing the residue left on a surface being wiped with the cleaning sheet.

Substrates for cleaning sheets useful in the present invention include, but are not limited to, those described in co-pending U.S. application Ser. No. 09/082,349 filed May 20, 1998 by Fereshtehkhou et al. (published as WO 98/52459); co-pending U.S. application Ser. No. 09/082,396 filed May 20, 1998 by Fereshtehkhou et al. (published as WO 98/52458); co-pending U.S. application Ser. No. 09/729,626 filed Nov. 30, 2000 by Wong et al.; U.S. Pat. No. 6,143,393 issued Nov. 7, 2000 to Abe et al.; U.S. Pat. No. 5,525,397 issued Jun. 11, 1996 to Shizuno et al.; EP 774,229 A2 published May 21, 1997; EP 777,997 A2 published Jun. 11, 1997; JP 09-224,895 published Sep. 2, 1997; and JP 09-313,416 published Dec. 9, 1997; which are all incorporated herein by reference.

### Preferred Hydroentangled Substrates

Hydroentangled substrates are particularly useful in the present invention due to their ability to effectively pick-up and retain particulate material from surfaces. Hydroentangled substrates can be woven or nonwoven, however, the preferred hydroentangled substrates of the present invention are nonwoven.

The present invention encompasses a wide variety of structures of hydroentangled substrates. The substrates can have relatively uniform basis weight across the entire area of the sheet, or the substrates can have discrete regions of differing basis weight. In addition, the substrates can have relatively flat surfaces, or the cleaning sheets can exhibit macroscopic three-dimensionality.

To enhance the integrity of the present hydroentangled cleaning sheets, it can be preferred, but not essential, to include a polymeric net (referred to herein as a “scrim” material) that is arranged with the fibrous material, e.g., though lamination via heat or chemical means such as adhesives, via hydrogentanglement. Scrim materials useful herein are described in detail in U.S. Pat. No. 4,636,419, which is incorporated herein by reference. The scrims may be formed directly at the extrusion die or can be derived from extruded films by fibrillation or by embossment, followed by stretching and splitting. The scrim may be derived from a polyolefin such as polyethylene or polypropylene, copolymers thereof, poly(butylene terephthalate), polyethylene terephthalate, Nylon 6, Nylon 66, and the like. Scrim materials are available from various commercial sources. A preferred scrim material useful in the present invention is a polypropylene scrim, available from Conwed Plastics (Minneapolis, Minn.).

Hydroentangled substrates suitable for the cleaning sheets of the present invention include those described in co-pending U.S. application Ser. No. 09/082,349 filed May 20, 1998 by Fereshtehkhou et al. (published as WO 98/52459); co-pending U.S. application Ser. No. 09/082,396 filed May 20, 1998 by Fereshtehkhou et al. (published as WO 98/52458); co-pending U.S. application Ser. No. 09/729,626 filed Nov. 30, 2000 by Wong et al.; and U.S. Pat. No. 5,525,397 issued Jun. 11, 1996 to Shizuno et al.

### Preferred Heat-Bonded Substrates

A preferred heat-bonded substrate of the present cleaning sheets comprises a base sheet and at least one layer comprising filaments or split yarns oriented in one direction, said base sheet and said layer being stacked and bonded together at a plurality of bonding lines extending in a direction intersecting with said one direction, said base sheet being cut together with said layer at a plurality of cutting portions aligned intermittently in said intersecting direction, thereby forming a plurality of brushing portions with said filaments or split yarns positioned between the bonding lines and the cutting portions in said one direction.

The base sheet can be comprised of any number of materials so long as the material has sufficient strength for use in a cleaning sheet, including nonwoven fabrics such as spunbonded webs, resin films, a synthetic fiber containing cloth, or the like.

The layer comprising filaments or split yarns can be formed of a great number of filaments or split yarns by orienting them in one direction and bundling them. The layer 3 may be formed only with the filaments or the split yarns or may be formed with both of the filaments and the split yarns.

The filaments can be formed into a material generally called as a tow, for example. The tow is a bundle comprising a number of oriented filaments. The filaments are prepared, for example, from polyethylene, polypropylene, nylon, polyester and rayon. Among them, composite fibers comprising polyester as a core component and polyethylene as a sheath component are preferably used.

The split yarns are prepared from a sheet shaped material such as a non-woven fabric or a film by cutting them into a rectangular shape with an extremely small width. Thus obtained rectangular materials i.e., split yarns are further bundled. Well-known non-woven fabric or film can be used. The rectangular material is preferably of a shape having such appropriate thickness and width as capable of catching dusts. The longitudinal size of the filament or the split yarn may be properly controlled as long as the size is greater than the distance between bonding lines that are adjacent with each other. Further, the filaments may be crimped as required.

The base sheet and the layer comprising filaments or split yarns preferably contain a thermoplastic resin. In this case, the layer and the base sheet are bonded by welding such as heat welding using hot emboss roll or ultrasonic welding. In this method, the thermoplastic resin contained in the base sheet and the layer comprising filaments or split yarns are welded together to form the bonding lines.

A process for manufacturing a preferred heat-bonded substrate for the present cleaning sheets comprises the steps of: (a) feeding a base sheet and at least one layer continuously and stacking said layer to said base sheet, wherein said layer comprises filaments or split yarns oriented in one direction; (b) bonding said base sheet and said layer at a plurality of bonding lines in a direction intersecting with said one direction to obtain a sheet material; (c) cutting said sheet material at a plurality of cutting portions aligned intermittently in said intersecting direction, thereby forming a plurality of brushing portions with said filaments or split yarns positioned between the bonding lines and the cutting portions; and (d) separating said sheet material to obtain a cleaning product.

A preferred heat-bonded substrate for the present cleaning sheets is described in further detail in U.S. Pat. No. 6,143,393 issued Nov. 7, 2000 to Abe et al., which is incorporated herein by reference. Other heat-bonded substrates suitable for the present cleaning sheets include those described in co-pending U.S. application Ser. No. 09/630,713, filed Aug. 2, 2000 by Kacher et al. (published as WO 01/11004), which is incorporated herein by reference.

B. Perfume

The cleaning sheets of the present invention further comprise a perfume affixed to the substrates of the cleaning sheets. Perfume is aesthetically important in cleaning sheets as it provides a positive scent signal to a consumer using the cleaning sheet, which reinforces the cleaning performance of the cleaning sheet. Cleaning sheets comprising perfume tend to be favored by many consumers because they can make cleaning chores more pleasant by providing the consumer a pleasing aroma, as compared to cleaning sheets that are free of perfume.

Perfume is typically affixed to the substrates of the present cleaning sheets at a level of from about 0.015 g/m² to about 5 g/m², preferably from about 0.05 g m² to about 2 g/m², and more preferably from about 0.07 g/m² to about 0.8 g/m², by weight of the cleaning sheet. The perfume is preferably uniformly distributed on the substrate. However, in some embodiments, it can be preferred to distribute the perfume and/or additive material non-uniformly on the substrate. It can be preferred to have “targeted” or “zoned” application of the perfume and/or additive material, especially when high levels of perfume and/or additive material are desired in concentrated areas that do not contact the surface being cleaned, such that residue problems are avoided. The perfume can be distributed on both sides of the substrate or on just one side of the substrate, preferably on at least one side of the substrate in contact with a surface being cleaned with the substrate.

It can be important to select certain perfume materials to create perfumes that connote “fresh and clean” odor characters. Such preferred odor characters include, but are not limited to, citrus odor character (i.e. lemon, orange, lime, and the like), outdoor odor character (i.e. green, woody, fruity, and the like), floral odor character (i.e. jasmine, lavender, orange flower, and the like), or the like.

Perfumes that have “fresh and clean” odor characters tend to comprise highly volatile perfume materials. As a result, the perfume tends to quickly volatilize off the substrate and the cleaning sheet quickly loses its perfume odor. It is thus important to include an additive material having a melting point of at least about −15° C., as described hereinafter, to minimize such perfumes from volatilizing off the substrates of the cleaning sheets.

In preferred embodiments, the perfume comprises certain levels and types of perfume materials which are characterized by their boiling point (B.P.). The boiling points of the perfume materials (ingredients) herein are determined at the normal, standard pressure of about 760 mmHg.

Boiling points of many perfume ingredients can be found in the following sources:

Properties of Organic Compounds Database CD-ROM Ver. 5.0

CRC Press

Boca Raton, Fla.

Flavor and Fragrance—1995

Aldrich Chemical Co.

Milwaukee, Wis.

STN database/on-line

Design Institute of for Physical Property Data

American Institute of Chemical Engineers

STN database/on-line

Beilstein Handbook of Organic Chemistry

Beilstein Information Systems

Perfume and Flavor Chemicals

Steffen Arctander

Vol. I, II—1969

When unreported, the 760 mmHg boiling points of perfume ingredients can be estimated. The following computer programs are useful for estimating these boiling points:

MPBPVP Version 1.25 C) 1994-96 Meylan

Syracuse Research Corporation (SRC)

Syracuse, N.Y.

ZPARC

ChemLogic, Inc.

Cambridge, Mass.

Non-limiting examples of volatile perfume materials having a boiling point of less than 250° C. include those in the following table:

| | Boiling Pt. | Boiling Pt. |
|---|---|---|
| Perfume Material | (° C.) (Meas.) | (° C.) (Pred.) |
| Allyl caproate | 186 | |
| Amyl acetate (n-Pentyl acetate) | 147 | |
| Amyl Propionate | 169 | |
| p-Anisaldehyde | 249 | |
| Anisole | 154 | |
| Benzaldehyde (Benzenecarboxaldehyde) | 179 | |
| Benzyl acetate | 211 | |
| Benzylacetone | 234 | |
| Benzyl alcohol | 205 | |
| Benzyl formate | 203 | |
| Benzyl isovalerate | | 256 |
| Benzyl propionate | 221 | |
| beta-gamma-Hexenol (2-Hexen-1-ol) | | 164 |
| (+)-Camphor | 207 | |
| (+)-Carvone | 231 | |
| L-Carvone | | 230 |
| Cinnamic alcohol | | 258 |
| Cinnamyl formate | 252 | |
| cis-Jasmone | | 253 |
| cis-3-Hexenyl acetate | | 175 |
| Citral (Neral) | 208 | |
| Cumic alcohol | 249 | |
| Cuminaldehyde | 235 | |
| Cyclal (2,4-Dimethyl-3- | | 203 |
| cyclohexene-1-carboxaldehyde) | | |
| Dimethyl benzyl carbinol | 215 | |
| Dimethyl benzyl carbinyl acetate | | 248 |
| Ethyl acetate | 77 | |
| Ethyl acetoacetate | 181 | |
| Ethyl amyl ketone | 167 | |
| Ethyl benzoate | 215 | |
| Ethyl butanoate | 121 | |
| 3-Nonanone (Ethyl hexyl ketone) | 187 | |
| Ethyl phenylacetate | 228 | |
| Eucalyptol | 176 | |
| Eugenol | 253 | |
| Fenchyl alcohol | 199 | |
| Flor Acetate (Tricyclodecenyl acetate) | | 233 |
| Frutene (Tricyclodecenyl propionate) | | 250 |
| gamma-Nonalactone | 243 | |
| trans-Geraniol | 230 | |
| cis-3-Hexen-1-ol/Leaf Alcohol | 156 | |
| Hexyl acetate | 171 | |
| Hexyl formate | 155 | |
| Hydratopic alcohol | | 233 |
| Hydroxycitronellal | 241 | |
| Indole (2,3-Benzopyrrole) | 254 | |
| Isoamyl alcohol | 131 | |
| Isopropyl phenylacetate | | 237 |
| Isopulegol | | 231 |
| Isoquinoline (Benzopyridine) | 243 | |
| Ligustral (2,4-Dimethyl-3- | | 204 |
| Cyclohexene-1-carboxaldehyde) | | |
| Linalool | 193 | |
| Linalool oxide | | 223 |
| Linalyl formate | | 212 |
| Menthone | | 214 |
| 4-Methylacetophenone | 226 | |
| Methyl pentyl ketone | 151 | |
| Methyl anthranilate | 256 | |
| Methyl benzoate | 199 | |
| Methyl Phenyl Carbinyl Acetate | | 216 |
| (alpha-Methylbenzyl acetate) | | |
| Methyl Eugenol (Eugenyl methyl ether) | 254 | |
| Methyl Heptenone | 173 | |
| (6-Methyl-5-hepten-2-one) | | |
| Methyl Heptine Carbonate | 218 | |
| (Methyl 2-octynoate) | | |
| Methyl Heptyl ketone | 195 | |
| Methyl Hexyl ketone | 173 | |
| Methyl salicylate | 223 | |
| Dimethyl anthranilate | 255 | |
| Neral | | 217 |
| Nerol | 225 | |
| delta-Nonalactone | | 226 |
| gamma-Octalactone | 256 | |
| 2-Octanol | 180 | |
| Octyl Aldehyde (Caprylic aldehyde) | 167 | |
| p-Cresol | 202 | |
| p-Cresyl methyl ether | 175 | |
| Acetanisole | 258 | |
| 2-Phenoxyethanol | 245 | |
| Phenylacetaldehyde | 195 | |
| 2-Phenylethyl acetate | 235 | |
| Phenethyl alcohol | 218 | |
| Phenyl Ethyl dimethyl Carbinol | | 257 |
| (Benzyl-tert-butanol) | | |
| Prenyl acetate | | 150 |
| Propyl butanoate | 143 | |
| (+)-Pulegone | 224 | |
| Rose oxide | | 197 |
| Safrole | 235 | |
| 4-Terpinenol | 211 | |
| Terpinolene (alpha-Terpineol) | 219 | |
| Veratrole (1,2-Dimethoxybenzene) | 206 | |
| Viridine (Phenylacetaldehyde | 220 | |
| dimethyl acetal) | | |
| Allo-ocimene | | 195 |
| Allyl cyclohexanepropionate | | 252 |
| Allyl heptanoate | | 209 |
| trans-Anethole | 232 | |
| Benzyl butyrate | 240 | |
| Camphene | 160 | |
| Cadinene | | 252 |
| Carvacrol | 238 | |
| cis-3-Hexenyl tiglate | | 225 |
| Citronellol | 223 | |
| Citronellyl acetate | 234 | |
| Citronellyl nitrile | 226 | |
| Citronellyl propionate | | 257 |
| Cyclohexylethyl acetate | 222 | |
| Decyl Aldehyde (Capraldehyde) | 208 | |
| Dihydromyrcenol | 192 | |
| Dihydromyrcenyl acetate | | 221 |
| 3,7-Dimethyl-1-octanol | 205 | |
| Diphenyloxide | 259 | |
| Fenchyl Acetate | | 234 |
| (1,3,3-Trimethyl-2-norbornanyl acetate) | | |
| Geranyl acetate | 233 | |
| Geranyl formate | | 231 |
| Geranyl nitrile | 228 | |
| cis-3-Hexenyl isobutyrate | | 204 |
| Hexyl Neopentanoate | | 213 |
| Hexyl tiglate | | 221 |
| alpha-Ionone | 237 | |
| Isobornyl acetate | 238 | |
| Isobutyl benzoate | 242 | |
| Isononyl acetate | | 220 |
| Isononyl alcohol | 194 | |
| (3,5,5-Trimethyl-1-hexanol) | | |
| Isopulegyl acetate | | 243 |
| Lauraldehyde | 250 | |
| d-Limonene | 177 | |
| Linalyl acetate | | 230 |
| (−)-L-Menthyl acetate | 227 | |
| Methyl Chavicol (Estragole) | 216 | |
| Methyl n-nonyl acetaldehyde | 247 | |
| Methyl octyl acetaldehyde | | 224 |
| beta-Myrcene | | 165 |
| Neryl acetate | 236 | |
| Nonyl acetate | 229 | |
| Nonaldehyde | 191 | |
| p-Cymene | 173 | |
| alpha-Pinene | 156 | |
| beta-Pinene | 166 | |
| Sabinene | | 157 |
| alpha-Terpinene | 175 | |
| gamma-Terpinene | 183 | |
| alpha-Terpinyl acetate | 220 | |
| Tetrahydrolinalool | 202 | |
| Tetrahydromyrcenol | 195 | |
| 2-Undecenal | | 235 |
| Verdox (o-t-Butylcyclohexyl acetate) | | 239 |
| Vertenex (4-tert.Butylcyclohexyl acetate) | | 237 |

Perfume can be comprised of volatile perfume raw materials (i.e. materials having a boiling point of less than 250° C.) and residual perfume raw materials (i.e. materials having a boiling point of greater than 250° C.), or a mixture of both. The perfume herein is preferably blended with the additive material herein and the blend is affixed to the substrate herein.

Developing perfumes for cleaning sheets can differ based on the desired consumer experience. A perfume comprised of mostly volatile perfume raw materials, for example, will allow for a very effective room odor after use (i.e. providing a perfume “bloom”). Perfumes developed with mostly residual perfume raw materials will allow for longer lasting odor on the cleaning sheet (i.e. product odor) after the package containing the cleaning sheets is opened. If the perfume embodies a mixture of volatile and residual perfume raw materials, the perfume can deliver room odor along with providing a longer lasting odor on the cleaning sheet.

In preferred embodiments, the perfume herein comprises at least about 0.01%, preferably at least about 50%, and more preferably about 100%, by weight of the perfume, of volatile perfume materials having a boiling point of less than 250° C. Preferred perfumes herein comprise at least one or more volatile perfume materials selected from the group consisting of d-limonene, neral, nerol, myrcene, geraniol, alpha-pinene, beta-pinene, gamma-terpinene, linalool, sabinene, and mixtures thereof.

The perfumes herein can also comprise perfume materials that are less volatile, i.e. residual perfume materials having a boiling point of greater than 250° C. Such residual perfume materials tend to be longer-lasting, even without the addition of additive material as described hereinafter. However, the additive material can still enhance perfume longevity of cleaning sheets comprising perfume that contains even relatively large amounts of residual perfume materials.

The perfume works in conjunction with the additive material to provide a long-lasting perfume odor to both the cleaning sheet itself and to the surface being cleaned with the cleaning sheets herein.

In general, the preferred perfumes herein will comprise rather limited amounts of residual perfume materials, for example, less than about 95%, preferably less than about 25%, and more preferably less than about 0.01%, by weight of the perfume. While cleaning sheets with highly volatile perfumes can impart perfume odor to the surface being cleaned with the sheets, if it is desired to impart a more significant perfume odor to the surface, it can be beneficial to have a perfume comprising greater amounts of residual perfume materials; for example, at least about 50%, preferably at least about 75%, and more preferably about 100%, by weight of the perfume.

Non-limiting examples of residual perfume materials having a boiling point of more than

| | Boiling Pt. | Boiling Pt. |
|---|---|---|
| | (° C.) | (° C.) |
| Perfume Material | (Meas.) | (Pred.) |
| Coumarin | 302 | |
| Ethyl methylphenylglycidate | 274 | |
| Ethyl Vanillin | 285 | |
| Isoeugenol | 266 | |
| Methyl cinnamate | 262 | |
| Methyl dihydrojasmonate | | 314 |
| Methyl beta-naphthyl ketone | 302 | |
| Phenoxy ethyl isobutyrate | | 277 |
| Vanillin | 285 | |
| (Ambrettolide) | | 352 |
| Oxacycloheptadec-10-en-2-one | | |
| (Amyl benzoate) n-Pentyl benzoate | | 263 |
| Isoamyl cinnamate | | 300 |
| alpha-Amylcinnamaldehyde | 289 | |
| alpha-Amylcinnamaldehyde | | 320 |
| dimethyl acetal | | |
| (iso-Amyl Salicylate) isopentyl salicylate | 277 | |
| (Aurantiol) Methyl | | 413 |
| anthranilate/hydroxycitronellal Schiff base | | |
| Benzophenone | 305 | |
| Benzyl salicylate | 320 | |
| beta-Caryophyllene | | 263 |
| Cedrol | | 274 |
| Cedryl acetate | | 289 |
| Cinnamyl cinnamate | | 387 |
| Citronellyl isobutyrate | | 266 |
| Cyclohexyl salicylate | | 327 |
| Cyclamen aldehyde | | 271 |
| delta-Dodecalactone | | 279 |
| (Dihydro Isojasmonate) Methyl 2-hexyl-3-oxo- | | |
| cyclopentanecarboxylate | | 314 |
| Diphenylmethane | 265 | |
| Ethylene brassylate | | 390 |
| Ethyl undecylenate | 261 | |
| Iso E Super | | 307 |
| (Exaltolide) Pentadecanolide | | 338 |
| (Galaxolide) 4,6,6,7,8,8-Hexamethyl- | | 335 |
| 1,3,4,6,7,8-hexahydro-cyclopenta(G)-2- | | |
| benzopyran | | |
| gamma-Methyl Ionone | | |
| (alpha-Isomethylionone) | | 278 |
| Geranyl isobutyrate | | 295 |
| Hexadecanolide | | 352 |
| cis-3-Hexenyl salicylate | | 323 |
| alpha-Hexylcinnamaldehyde | | 334 |
| n-Hexyl salicylate | | 318 |
| alpha---Irone | | 279 |
| 6-Isobutylquinoline | | 294 |
| Lilial (p-tert.Butyl-alpha- | | 282 |
| methyldihydrocinnamic aldehyde, PT Bucinol) | | |
| Linalyl benzoate | | 325 |
| (2-Methoxy Naphthalene) beta-Naphthyl | 274 | |
| methyl ether | | |
| 10-Oxahexadecanolide | | 355 |
| Patchouli alcohol | | 317 |
| (Phantolide) 5-Acetyl-1,1,2,3,3,6- | | 333 |
| hexamethylindan | | |
| Phenethyl benzoate | | 335 |
| Phenethyl phenylacetate | | 350 |
| Phenyl Hexanol (3-Methyl-5-phenyl-1- | | 296 |
| pentanol) | | |
| Tonalid (7-Acetyl-1,1,3,4,4,6- | | 344 |
| hexamethyltetralin) | | |
| delta-Undecalactone | | 262 |
| gamma-Undecalactone | 286 | |
| Vertinert Acetate | | 332 |

As noted hereinbefore, the perfume is preferably affixed to the substrate along with an additive material having a melting point of at least about −15° C., to provide a cleaning sheet having a long-lasting perfume odor. The resulting cleaning sheet is also able to provide a long-lasting perfume odor to the surface being cleaned. The perfume and additive material can be affixed separately to the substrate or can be first blended together and then the blend can be affixed to the substrate.

C. Additive Material

The longevity of the perfume odor of the cleaning sheets of the present invention is enhanced by affixing an additive material having a melting point of at least about −15° C. to the substrate of the present cleaning sheets. The additive materials herein tend to control or regulate the more volatile perfume raw materials from volatilizing off of the cleaning sheets. If perfume alone is affixed to the substrates of the cleaning sheets, the perfume tends to quickly volatilize off of the cleaning sheet. As a result, the cleaning sheet quickly loses its perfume odor.

Another benefit of the unique combination of perfume and additive material as described herein is that the present cleaning sheets are capable of providing a long-lasting perfume odor to the surface being cleaned. In this respect, a small amount of the blend of perfume and additive material is transferred to the surface being cleaned. The additive material then provides a slow release of the perfume over time. Furthermore, the blend of perfume and additive material herein typically does not result in filming or streaking of the surface being cleaned.

The benefits resulting from the use of the additive material described herein are typically achieved when a blend of perfume and additive material is provided in a solid, semi-solid, or solid-like continuous mixture. Most perfumes are volatile liquids at room temperature. By addition of the additive material, the perfume is thus contained in a solid, semi-solid, or solid-like continuous blend. The additive material can be selected to achieve a certain melting profile, for example, to be a liquid at a low enough processing temperature to be safe with respect to processing conditions (due to flashpoint of perfume) while also giving a solid, semi-solid, or solid-like continuous mixture at room temperature. The additive material can also be selected to achieve a certain blend “hardness”. The hardness of the blend of perfume and additive material can be adjusted by variation of the components of the additive material to give a desirable perfume diffusion rate. Slower perfume diffusion is typically observed in more solid-like blends as compared to liquids. The diffusion of perfume is dramatically affected by the hardness of a blend. Also, the hardness could be varied to give a desirable in-use character—such as feel, and/or residue deposition. This is reflected in Example II hereinafter.

By selection of suitable component, components, and/or mix ratios of the additive material, the melting and freezing profile can be varied, and, variation in the diffusivity can be varied with the of the degree of “hardness” of the blend. One example is an additive consisting of paraffin wax and mineral oil. The “hardness” of the blend can be varied from can be solid, semi-solid, or solid-like continuous blend. This particular blend offers good flexibility in regulating diffusivity of perfume, while at the same time gives advantageous thermal character.

The additive material also can enhance the ability of the cleaning sheet to pick-up and retain particulate matter, such as dust or the like, from the surfaces contacted or wiped with the cleaning sheet.

The additive material is preferably affixed to the cleaning sheet at an add-on level of at least about 0.04 g/m², more preferably at least about 1 g/m², and more preferably at least about 2.5 g/m², by weight of the cleaning sheet. Typically, the add-on level of the additive material is from about 0.04 g/m² to about 35 g/m², more preferably from about 1 g/m² to about 5 g/m², more preferably from about 2 g/m² to about 3 g/m², by weight of the cleaning sheet. The level and type of additive material is selected to minimize perfume loss and to minimize the residue that is left of the surface wiped with the present cleaning sheets to leave the surface visually acceptable to consumers. The level and type of additive material is also selected to increase the cleaning performance of the cleaning sheet.

The additive materials suitable for cleaning sheets of the present invention have a melting point of at least about −15° C., preferably at least about 20° C., and more preferably at least about 35° C. The melting point of the additive material is important such that when the additive material is affixed to the substrate along with the perfume, the additive material is able to effectively reduce the loss of perfume odor from the present cleaning sheets. Additive materials having too low of a melting point tend not to be able to effectively reduce the loss of perfume odor from the present cleaning sheets.

A wide variety of additive materials, including mixtures of different components, are suitable for use in the present cleaning sheets, so long as the melting point of the additive material is at least about −15° C. The following table provides non-limiting examples of suitable additive materials for the present cleaning sheets:

| Additive Material | Melting Point (° C.) |
|---|---|
| Paraffin Wax ^{a} | 53 to 57 |
| Microcrystalline Wax ^{b} | 88 to 93 |
| Carnauba Wax ^{c} | At least 83 |
| White Ozkerite Wax ^{d} | 72 to 76 |
| Cetyl Alcohol ^{e} | 47 to 50 |
| Stearyl Alcohol ^{f} | 56 to 60 |
| Sorbitan Stearate ^{g} | 56 to 58 |
| Glycerine ^{h} | 20 |

^{a} Commercially available from Strahl & Pitcsh under the trade name S&P No. 2278.
^{b} Commercially available from Strahl & Pitcsh under the trade name S&P No. 617.
^{c} Commercially available from Strahl & Pitcsh under the trade name S&P No. 63.
^{d} Commercially available from Strahl & Pitcsh under the trade name S&P No. 1028.
^{e} Commercially available from The Procter & Gamble Co. under the trade name CO-1695.
^{f} Commercially available from The Procter & Gamble Co. under the trade name CO-1895.
^{g} Commercially available from ICI under the trade name Span 60.
^{h} Commercially available from The Procter & Gamble Co. under the trade name Star.

Preferably, the additive material has a melting point that is less than about 150° C., more preferably less than about 90° C., and even more preferably less than about 70° C.

It should be noted that the additive material can comprise a number of different components, so long as the additive material mixture has a melting point of at least about −15° C. For example, the additive material can comprise a first component having a melting point of at least about −15° C. (e.g. paraffin wax, which has a melting point of about 50° C.) and a second component having a melting point of less than about −15° C. (e.g. mineral oil, which has a melting point of −18° C.), so long as the combination of the first and second components results in an additive material having a melting point of at least about −15° C. In this example, the levels of the first and second components are adjusted such that the additive material has the requisite melting point.

A preferred additive material comprises a wax or a mixture of an oil (e.g., mineral oil, etc.) and a wax. Suitable waxes include various types of hydrocarbons, as well as esters of certain fatty acids (e.g., saturated triglycerides) and fatty alcohols. They can be derived from natural sources (i.e., animal, vegetable or mineral) or can be synthesized. Mixtures of these various waxes can also be used. Some representative animal and vegetable waxes that can be used in the present invention include beeswax, carnauba, spermaceti, lanolin, shellac wax, candelilla, and the like. Representative waxes from mineral sources that can be used in the present invention include petroleum-based waxes such as paraff, petrolatum and microcrystalline wax, and fossil or earth waxes such as white ceresine wax, yellow ceresine wax, white ozokerite wax, and the like. Representative synthetic waxes that can be used in the present invention include ethylenic polymers such as polyethylene wax, chlorinated naphthalenes such as “Halowax,” hydrocarbon type waxes made by Fischer-Tropsch synthesis, and the like. Other preferred additives are supplied as mixtures of wax and oil, such as petrolatum. Such additives can be used by themselves or in combination with other wax and oils.

A preferred additive material is a mixture of a wax and mineral oil, as it enhances the ability of the cleaning sheet to pick up and retain particulate material from surfaces, while minmizing the amount of residue left on the surface being wiped with the cleaning sheet. When a mixture of mineral oil and wax is utilized, the components will preferably be mixed in a ratio of wax to oil of from about 1:99 to about 99:1, more preferably from about 1:99 to about 10:1, still more preferably from about 1:1 to about 7:3, by weight of the additive material. In a particularly preferred embodiment, the ratio of wax to oil is about 7:3, by weight. The additive material can be applied at an add-on level of from about 0.04 g/m² to about 35 g/m², preferably from about 1.7 g/m² to about 15 g/m², and more preferably about 2.7 g/m², by weight. A preferred mixture is a 7:3 mixture of paraffin wax and mineral oil.

Wax alone, such as paraffin wax, can be utilized as an additive material to the present cleaning sheets. Where the additive material consists of only a wax, the cleaning sheets are preferably comprised of synthetic fibers, so that the cleaning sheet is still able to maintain electrostatic properties to provide enhanced particulate material pick-up and retention. In any event, if the cleaning sheet comprises natural and/or synthetic fibers, an additive material that consists essentially of wax is typically applied to the substrates of the present cleaning sheets at an add-on level of no greater than about 35 g/m², preferably no greater than about 15 g/m², more preferably no greater than about 5 g/m², and even more preferably no greater than about 3 g/m², by weight of the cleaning sheet. These levels are preferred because if a wax additive is applied to the cleaning sheets at higher levels, the electrostatic properties of the sheet will typically be diminished, and therefore decrease the overall cleaning performance of the sheet. Preferably, the additive material does not significantly diminish the electrostatic properties of the cleaning sheet. It is preferable that the cleaning sheet of the present invention have electrostatic properties in order to facilitate pick-up and retention of particulate material, especially for fine dust particulate material. In this respect, the present cleaning sheet are preferably essentially free of, or free of, cationic surfactants, as cationic surfactants would tend to negate the electrostatic properties of the present cleaning sheets.

These low levels are especially desirable when additive materials are applied at an effective level and preferably in a substantially uniform way to at least one discrete continuous area of the sheet. Use of the preferred lower levels, especially of additive materials that improve adherence of soil to the sheet, provides surprisingly good cleaning, dust suppression in the air, preferred consumer impressions, especially tactile impressions.

The additive material can also comprise materials that can form complexes with perfumes. For example, the perfume can be complexed with cyclodextrin to form a perfume complex and then the complex can be affixed to the substrate or blended with the additive material and affixed to the substrate. Perfume/cyclodextrin complexes are described in more detail in U.S. Pat. Nos. 5,102,564 and 5,234,610, which is incorporated herein by reference. In a preferred embodiment, however, the cleaning sheet is essentially free of cyclodextrin. Other complexing materials include starch encapsulated accords (“SEAs”), microcapsules, and the like.

In a preferred embodiment, the perfume and additive material are first blended together and then affixed to the substrate, such that the blend of perfume and additive material has a melting point of at least about 20° C., preferably at least about 25° C., and more preferably at least about 35° C. In this respect, the level of perfume and level of additive material are adjusted such that the blend of perfume and additive material has the requisite melting point. For example, the perfume and additive material are preferably present in a ratio of additive material to perfume of from about 1:2 to about 30:1, more preferably from about 1:1 to about 25:1, and even more preferably from about 9:1 to about 19:1, by weight. In a preferred embodiment, the ratio of additive material to perfume is about 9:1.

The types and levels of perfume and additive material are preferably selected such that the cleaning sheet is substantially dry to the touch, for example, the preferred cleaning sheets herein are not moistened or premoistened cleaning sheets. In this respect, the additive material is preferably substantially non-aqueous, meaning that only slight traces of water are present, if at all.

II. Cleaning Implements

In another aspect, the present invention relates to a cleaning implement comprising the cleaning sheets, discussed herein, removably attached to a handle. In this regard, the cleaning implement comprises a handle; and a removable cleaning sheet comprising a substrate having affixed thereto perfume and additive material having a melting point of at least about −15° C.

The handle of the cleaning implement comprises any elongated, durable material that will provide ergonomically practical cleaning. The length of the handle will be dictated by the end-use of the implement. A suitable handle for the present cleaning implements is shown in detail in U.S. Pat. No. D409,343, which is incorporated herein by reference.

The handle will preferably comprise at one end a support head to which the cleaning sheet can be releasably attached. To facilitate ease of use, the support head can be pivotably attached to the handle using known joint assemblies. Any suitable means for attaching the cleaning sheet to the support head can be utilized, so long as the cleaning sheet remains affixed during the cleaning process. Examples of suitable fastening means include clamps, hooks & loops (e.g., VELCRO®), and the like. In a preferred embodiment, the support head will comprise means for gripping the sheet on its upper surface to keep the sheet mechanically attached to the head during the rigors of cleaning. However, the gripping means will readily release the sheet for convenient removal and disposable. Suitable gripping means are described in more detail in co-pending U.S. application Ser. No. 09/374,714 filed Aug. 13, 1999 by Kingry et al. (published as WO 01/12052), which is incorporated herein by reference.

III. Process of Manufacture

The substrates of the present cleaning sheets are manufactured according to processes described in the art, particularly in the patents incorporated herein by reference. The perfume and additive material can be affixed to the substrate either during the manufacture of the substrate or after manufacture of the substrate. Preferably, the perfume and additive material are affixed to the substrate in a line operation, wherein the substrate is first formed and then the perfume and additive material are affixed to the substrate immediately after formation of the substrate.

The perfume and additive material can be applied to the substrates of the present cleaning sheets via a variety of application methods. Such methods include manual rolling, mechanical rolling, slotting, ultrasonic spraying, pressurized spraying, pump spraying, dipping, and the like. A preferred method of application of the perfume and additive material to the substrate is by ultrasonic spraying. In order to spray the perfume and additive material onto the substrate, the additive material is preferably heated to a temperature at which the additive material becomes liquid and then the perfume is blended with the additive material. The blend of perfume and additive material is then uniformly sprayed onto the substrate of the cleaning sheet.

Another preferred embodiment of the process is using ultrasonic spraying to separately apply the perfume and the additive material to the substrate. In this process, the perfume can firstly be sprayed onto the substrate and then the additive material can be heated to a temperature at which it becomes liquid and sprayed onto the substrate containing the perfume. In this process, the additive material can form a coating layer over the perfume.

Another preferred method of application of the perfume and additive material to the substrate of the cleaning sheet is by mechanical rolling. During the process of making the substrates, the substrates are fed through a set of rollers that are coated with the blend of perfume and additive material to be applied. The rollers can be coated with the additive by rotating in a pan or reservoir containing the perfume and additive material. As the substrates are fed through the rollers, the perfume and additive material are transferred from the rollers to the substrates of the cleaning sheets. In such a process, the additive material is heated in the pan or reservoir to a temperature at which the additive material becomes liquid and then the perfume is blended with the additive material. The blend of perfume and additive material is then maintained at a temperature high enough to maintain the blend of perfume and additive material in liquid form. In a preferred embodiment, wherein the additive material comprises a mixture of a wax and mineral oil, particularly in a ratio of wax to mineral oil of 7:3, a mix tank containing the additive material is preferably heated to a temperature of from about 32° C. to about 90° C., preferably from about 35° C. to about 70° C., in order to maintain the additive material in a fluid state. The perfume is then blended with the additive material in the mix tank and conveyed to the application pan and rollers. In such a situation, the pan and rollers are also preferably heated to a temperature similar to the temperature of the hot blend of perfume and additive material in a fluid state. As with a spraying process, the perfume and additive material can be applied to the substrate separately.

For small scale production of the present cleaning sheets, the additive can also be applied to the cleaning sheet via manual rolling, which comprises taking a hand-held roller, coating the roller with additive, and rolling the roller across the surface of the cleaning sheet.

IV. Methods of Use

The cleaning sheets and, separately, the cleaning implements of the present invention are designed to be compatible with all hard surface substrates, including wood, vinyl, linoleum, no wax floors, ceramic, FORMICA®, porcelain, and the like. They have also been found to be effective on surfaces like walls, ceilings, upholstery, drapes, rugs, clothing, etc., where dusting sheets have not normally been used.

As a result of the ability of the cleaning sheets to reduce, or eliminate, by various means, including contacting and holding, dust, lint and other airborne matter from surfaces, as well as from the air, the sheets will provide greater reduction in the levels of such materials on surfaces and in the atmosphere, relative to other products and practices for similar cleaning purposes. This ability is especially apparent in sheets containing additive materials as described herein. Therefore it is important to provide this information on the package, or in association with the package, so as to encourage the use of the sheets, especially on the non-traditionally dusted surfaces like walls, ceilings, upholstery, drapes, rugs, clothing, etc.

The methods of the present invention generally comprise the step of contacting, preferably wiping, a surface with a cleaning sheet described herein. A preferred embodiment encompasses a method of removing dust (or the like) from a surface comprising the step of contacting, preferably wiping, the surface with a cleaning sheet described herein.

As discussed hereinbefore, the cleaning sheets of the present invention can be particularly effective in imparting a perfume odor to the surface being cleaned with the cleaning sheet, in addition to removing dust or the like from the surface. As a result, another preferred embodiment of the present methods relates to a method of imparting a perfume odor to a surface and, optionally, removing dust (or the like) from the surface comprising the step of contacting, preferably wiping, the surface with a cleaning sheet described herein.

V. Articles of Manufacture

In another aspect, the present invention relates to an article of manufacture comprising the cleaning sheets described herein packaged in a container. The container can be any one of a variety of containers, including, for example, paperboard cartons, flow wrap, odor barrier overwrap, laminated cartons, and the like.

A preferred package for the present cleaning sheets is a paperboard carton having an inner surface that is laminated or sprayed with a film to serve as a barrier and to minimize the amount of perfume volatilizing from the cleaning sheets and escaping through the carton. A preferred film is an oriented polypropylene film. Suitable oriented polypropylene films are commercially available from ExxonMobil Chemical under the trade names BICOR® AOH and BICOR® AXT. The oriented polypropylene film is preferably laminated to the inner surface of the paperboard carton.

### EXAMPLE I

This Example illustrates the manufacture of a preferred cleaning sheet of the present invention. Two carded polyester fiber webs, having a denier of 1.5 denier, are prepared. The combination of the two carded webs and a scrim material are placed on top of a forming belt. The webs are then hydroentangled with the scrim material to form a substrate and dried. The water entangling process causes the fibers to become entangled with each other and with the scrim material, while causing the fibers to move apart and provide two distinct basis weight regions. The substrate is then dried, and slit into the appropriate widths to be coated, folded and packaged. The perfume additive is produced by first receiving a pre-blended ratio of paraffin wax and mineral oil. The blend is received in a molten state via tank truck. The wax/oil blend is off loaded into an electrically heated mix tank and held at 60° C. The mix is recirculated and agitated using an air top mount style agitator. The agitator is activated with the agitator blade turning at about 40 rpm and the perfume is then added. The additive and perfume is mixed until homogenous. The combined mix of perfume, wax, oil is then pumped to a series of pans or reservoirs. The pans are mounted under the applicator rolls. The applicator rolls are a type of gravure roll containing individual cells. The applicator rolls are immersed in the fluid in the pans, rotating in the molten liquid, picking up the mix with the cells and depositing the mix on the substrate. As the substrate is pulled over the applicator rolls the mix is deposited on the substrate at the desired coating weight. Applicator roll speed, applicator roll cell size/dimension, and mix viscosity are the key levers to regulate the amount of mix deposited on the web.

### EXAMPLE II

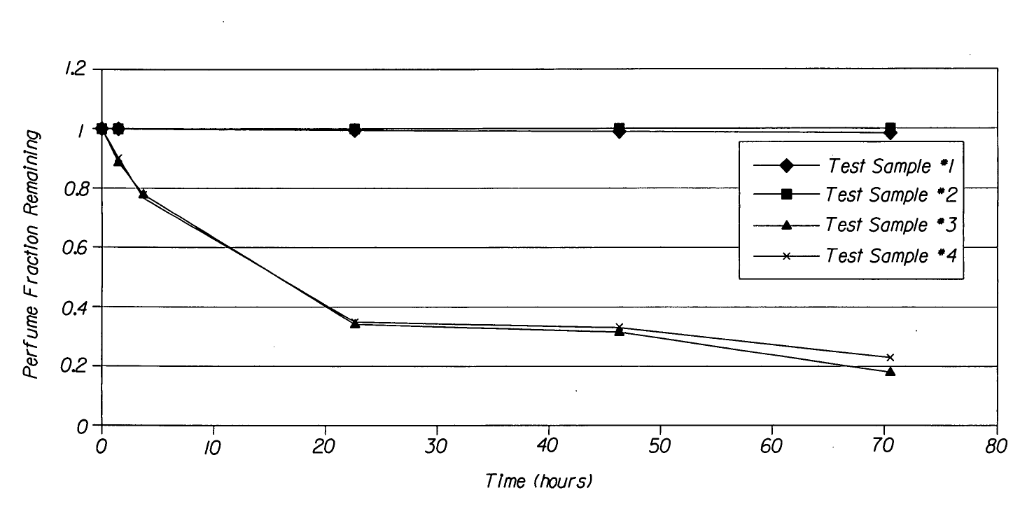

This Example provides an experimental procedure that simulates the effectiveness of an additive material having a melting point of at least about −15° C. in preventing the loss of perfume odor of a cleaning sheet over time. The results of this experiment are shown in FIG. 1 as a graph of Perfume Fraction Remaining versus Time (hours).

Four test samples are prepared having the following compositions, by weight:

Test Sample #1: 70% paraffin wax and 30% perfume

Test Sample #2: 49% paraffin wax, 21% mineral oil, and 30% perfume

Test Sample #3: 70% mineral oil and 30% perfume

Test Sample #4: 100% perfume

Approximately 29 grams of each test sample is placed in separate round aluminum pans, each pan having a diameter of 10 centimeters. The total mass of the pan containing the test sample is measured initially and then stored in a laboratory hood at room temperature. The total mass of the pan containing the test sample is then measured at the following time intervals: 1.5 hours, 3.5 hours, 22.5 hours, 46.5 hours, and 70.5 hours. At each time interval, the total mass at the given time interval is determined. This is subtracted from the total mass measured initially to calculate the mass of perfume lost at the given time interval. Subtracting the mass of perfume lost from the initial mass of perfume gives the mass of perfume remaining, which is then divided by the initial mass of perfume, and this value is reported as the “Perfume Fraction Remaining”. After the data is collected, the results are plotted in terms of “Perfume Fraction Remaining” as a function of “Time (hours)”.

The results for Test Samples #14 are shown in FIG. 1. The graph in FIG. 1 shows that combining the perfume with an additive material having a melting point of at least about −15° C., here paraffin wax having a melting point of about 50° C., is significant in altering the perfume volatilization rates, as compared to additive material having a melting point of less than about −15° C., here mineral oil having a melting point of −18° C., or with no additive material present at all.

What is claimed is:

1. A cleaning sheet comprising:
(a) a substrate;
(b) perfume; and
(c) additive material having a melting point of at least about −15° C.;
wherein said perfume and said additive material are affixed to said substrate.

2. A cleaning sheet according to claim 1 wherein said additive material comprises a wax.

3. A cleaning sheet according to claim 2 wherein said wax is selected from the group consisting of synthetic waxes, natural waxes, and mixtures thereof.

4. A cleaning sheet according to claim 3 wherein said wax is paraffin wax.

5. A cleaning sheet according to claim 2 wherein said wax is present on said substrate at a level of from about 0.04 g/m² to about 35 g/m², by weight of said cleaning sheet.

6. A cleaning sheet according to claim 2 wherein said perfume is present on said substrate at a level of from about 0.015 g/m² to about 5 g/m², by weight of said cleaning sheet.

7. A cleaning sheet according to claim 2 wherein said additive material and said perfume are present on said substrate at a ratio of said additive material to said perfume of from about 1:2 to about 30:1.

8. A cleaning sheet according to claim 2 wherein said additive material further comprises an oil.

9. A cleaning sheet according to claim 8 wherein said additive material comprises a ratio of said wax to said oil of from about 99:1 to about 1:99.

10. A cleaning sheet according to claim 1 wherein said additive material has a melting point of from about 20° C. to about 90° C.

11. A cleaning sheet according to claim 10 wherein said additive material has a melting point of from about 35° C. to about 70° C.

12. A cleaning sheet according to claim 1 wherein said perfume and said additive material are blended together and affixed to said substrate, wherein said blend of said perfume and said additive material has a melting point of at least about 20° C.

13. A cleaning sheet according to claim 12 wherein said blend of said perfume and said additive material has a melting point of at least about 25° C.

14. A cleaning sheet according to claim 13 wherein said blend of said perfume and said additive material has a melting point of at least about 30° C.

15. A cleaning sheet according to claim 1 wherein said additive material is substantially non-aqueous.

16. A cleaning sheet according to claim 1 wherein said additive material is essentially free of cationic surfactant.

17. A cleaning sheet according to claim 1 wherein said substrate is a nonwoven substrate.

18. A cleaning sheet according to claim 17 wherein said nonwoven substrate comprises synthetic fibers.

19. A cleaning sheet according to claim 18 wherein said synthetic fibers are hydroentangled.

20. A cleaning sheet according to claim 1 wherein said substrate is a heat-bonded substrate.

21. A cleaning sheet according to claim 20 wherein said heat-bonded substrate comprises a base sheet and at least one layer comprising filaments oriented in one direction, said base sheet and said layer being bonded together at a plurality of bonding lines extending in a direction intersecting with said one direction, said base sheet being cut together with said layer at a plurality of cutting portions aligned intermittently in said intersecting direction, thereby forming a plurality of brushing portions with said filaments positioned between said bonding lines and said cutting portions in said one direction.

22. A cleaning sheet according to claim 1 wherein said substrate has a total aggregate basis weight of from about 20 g/m² to about 275 g/m².

23. A cleaning sheet according to claim 22 wherein said substrate has a total aggregate basis weight of from about 40 g/m² to about 200 g/m².

24. A method of removing debris from a surface comprising the step of contacting said surface with a cleaning sheet according to claim 1.

25. A method of imparting perfume odor to a surface comprising the step of contacting said surface with a cleaning sheet according to claim 1.

26. A process of manufacturing a cleaning sheet having long-lasting perfume odor, said process comprising the steps of:
(a) providing a substrate;
(b) applying a perfume to said substrate;
(c) heating an additive material having a melting point of at least about −15° C. to at least a temperature wherein said additive material becomes liquid; and
(d) applying said additive material to said substrate.

27. A process according to claim 26 wherein said perfume and said additive material are applied to said substrate via mechanical rolling.

28. A process according to claim 26 wherein said perfume and said additive material are applied to said substrate via ultrasonic spraying.

29. A process according to claim 26 wherein said perfume and said additive material are blended together to form a blend of said perfume and said additive material and then said blend is applied to said substrate

30. A process according to claim 26 wherein said perfume is firstly applied to said substrate and then said additive material is separately applied to said substrate.
